(19) United States
(12) Patent Application Publication
(10) Pub. No.: US 2004/0010652 A1
(43) Pub. Date: Jan. 15, 2004

(54) System-on-chip (SOC) architecture with arbitrary pipeline depth

(75) Inventors: Lyle E. Adams, San Jose, CA (US); Ronald H. Nicholson, Santa Clara, CA (US); S. Jauher A. Zaidi, Cupertino, CA (US)

Correspondence Address: BOOTH & WRIGHT LLP, P O BOX 50010, AUSTIN, TX, 78763-0010, US

(73) Assignee: Palmchip Corporation, San Jose, CA

(21) Appl. No.: 10/602,581

(22) Filed: Jun. 24, 2003

Related U.S. Application Data
(63) Continuation of application No. 10/180,866, filed on Jun. 26, 2002.
(60) Provisional application No. 60/300,709, filed on Jun. 26, 2001.
(60) Provisional application No. 60/302,864, filed on Jul. 5, 2001.
(60) Provisional application No. 60/304,909, filed on Jul. 11, 2001.
(60) Provisional application No. 60/390,501, filed on Jun. 21, 2002.

(51) Int. Cl. G06F 13/28

(52) U.S. Cl. 710/313; 710/22

(57) ABSTRACT

An SOC architecture that provides a latency tolerant protocol for internal bus signals is disclosed. The SOC includes at least a processor core and one or more peripherals that communicate on a first internal bus that carries signals having a latency tolerant signal protocol that enables an arbitrary number of pipeline stages between any signal initiator and any signal target. A shared memory subsystem, DMA-type peripherals, and a second internal bus with a topology overlapping the first bus, may also be included. All signals over both busses are point-to-point and registered and all transactions on both busses are handshaked. An arbitrary number of flip-flops, multiplexing routers, and/or decoding routers may be included between any signal initiator and any signal target on either bus, and may be added at any time during the design and layout of the SOC.

### CROSS REFERENCE TO RELATED APPLICATIONS

This application claims the benefits of the earlier filed U.S. Provisional Application Serial No. 60/300,709, filed Jun. 26, 2001 (26.06.2001), which is incorporated by reference for all purposes into this specification.

Additionally, this application claims the benefits of the earlier filed U.S. Provisional Application Serial No. 60/302,864, filed Jul. 5, 2001 (05.07.2001), which is incorporated by reference for all purposes into this specification.

Additionally, this application claims the benefits of the earlier filed U.S. Provisional Application Serial No. 60/304,909, filed Jul. 11, 2001 (11.07.2001), which is incorporated by reference for all purposes into this specification.

Additionally, this application claims the benefits of the earlier filed U.S. Provisional Application Serial No. 60/390,501, filed Jun. 21, 2002 (21.06.2002), which is incorporated by reference for all purposes into this specification.

Additionally, this application is a continuation of the earlier filed U.S. patent application Ser. No. 10/180,866, filed Jun. 26, 2002 (26.06.2002), which is incorporated by reference for all purposes into this specification.

### BACKGROUND OF THE INVENTION

1. Field of the Invention

The present invention relates to the design of generally synchronous digital System-on-Chip (SOC) architectures. More specifically, the present invention relates to an interconnection architecture having a generally synchronous protocol that simplifies the floorplanning of complex SOC designs by enabling the placement of bussed signal initiators and targets to be a matter of convenience rather than a matter of logic timing or synchronization.

2. Description Of The Related Art

As silicon chip sizes increase and as transistor technology shrinks, the relative distances separating components becomes greater, forcing the interconnections between the components to grow larger. Standard methods of physically interconnecting on-chip components, three of which are shown in FIGS. 1A, 1B, and 1C, can have several problems. The bussed interconnection approach shown in FIG. 1A, where signals travel along a central bus, is a very effective routing methodology that can simplify the chip floorplanning and layout task. However, in a very large or complex chip, the drive strength required to propagate a bussed signal from one component to another can become excessive, or the speed of the transition reduces so much that high-speed operation is not possible. In small-footprint chips, similar problems can arise as manufacturing technology has enabled the use of transistors having very small gates as compared to the size of the interconnect wiring. The point-to-point interconnect approach shown in FIG. 1B solves this problem by reducing the wire length, and allowing buffers—repeaters—to be placed long the wire length, maintaining signal transition speed. This approach creates a very large number of wires. As the chip size and transistor count increases, the number of interconnects increases, and it becomes very difficult to route all of the wires effectively. An interconnect fabric, such as that shown in FIG. 1C, can solve the interconnect layout problem by reducing the total number of required wires (like a bussed interconnect) while simultaneously keeping the average distance a signal must travel from source to recipient somewhat shorter than a bus (like a point-to-point interconnect). However, while the interconnect fabric approach provides a solution that avoids degradation of the signal transition speed, the chip's clock speed is still limited by the relatively long distances signals must travel from source to recipient, particularly in larger, more complex integrated circuits and chips using small-geometry transistors. In a synchronous digital system, the clock cycle must be long enough to allow signals to propagate from the source gate to the recipient gate in one cycle.

The common solution to the problem of extended signal propagation times caused by the physical interconnect is pipelining—reducing the distance that must be traversed within a single clock cycle by inserting a flip-flop (also referred to herein as a register) in the path to capture and re-launch the signal. In other words, the pipelined signal travels from the source gate to the ultimate recipient gate within two clock cycles—from the signal source to the flip-flop during the first cycle, and from the flip-flop to the recipient during the second clock cycle. More flip-flops can be added in the signal path as required to further decrease the distance the signal must propagate in a single clock cycle, thus enabling shorter and shorter clock cycles (and thus higher and higher speed operation.)

However, those skilled in the art understand that this pipelining does have its own drawbacks. First, there is a point of diminishing returns. Adding pipeline stages to enable higher-speed operation can decrease the overall performance of the chip, even though it may be running faster, by introducing more opportunities for the chip to stall while awaiting the arrival of a deeply-pipelined signal at a critical gate. Moreover, since the delay between a signal's source gate and recipient gate is not known until after floorplanning, layout, and/or delay extraction of the chip, designers may not become aware that they have a signal distance problem, hence an operating frequency limitation, until relatively late in the design process. Adding unplanned-for pipeline stages this late in the design process can cause logic timing and synchronization problems, which then require some degree of redesign. The usual result is that the chip design and layout processes are iterative, often requiring several passes before an optimum design/layout balance is reached.

Processor designers have long employed pipelining to achieve higher operating frequencies and better performance from ever-more complex processor designs, working around the above-described limitations. Designers have set fixed pipeline depths for certain signals early in the design process, so that the pipelined signal's arrival time at the intended recipient gate is predictable and repeatable. Obviously, knowing when a signal will arrive at an intended gate simplifies the design from a timing and logic synchronization perspective. Moreover, the designer can minimize the potential performance hit associated with adding pipeline stages, because the designer can insure that all required signals to perform a process or function typically arrive at the proper gate during the same clock cycle or within a few clock cycles of each other. Finally, fixed pipeline depths can be used in chips that utilize a standard processor or other “core” design, because the physical size of the core is known ahead of time. When the chip's physical size and transistor locations are fixed and known beforehand, then interconnect distances are generally fixed, and the appropriate number and location of pipeline stages are simply built into the design.

However, in the System-On-Chip (“SOC”) world, things are not nearly so predictable. The term SOC, as used herein, refers to an integrated circuit that generally includes a processor, embedded memory, various peripherals, and an external bus interface. In the past, an electronic system designed to perform one or more specific functions would be based on a printed circuit board populated with a microprocessor or microcontroller, memory, discrete peripherals, and a bus controller. Today, such a system can fit on a single chip, hence the term System-on-Chip. This advancement in technology allows system designers to utilize a single, predesigned, off-the-shelf chip to accomplish certain functions, thus reducing overall system cost, size, weight, and testing requirements, while ordinarily improving system reliability.

In designing an SOC, chip designers strive to balance chip functionality, operating frequency and power, and chip size. Some features can only be achieved at the expense of others. Obviously, the on-chip interconnects must be designed to work even when other chip characteristics, such as size and maximum operating frequency, are unknown. For the reasons described above, SOC designers typically want to avoid having to add unplanned-for pipeline stages at the floorplanning stage, but because SOC designers never know the ultimate size of their designs until floorplanning is complete, stages often have to be added at the last minute. This initiates the undesirable iterative design/layout procedure described above, adding to the cost of the chip and delaying the time-to-market. A design architecture that is impervious to the last-minute addition of pipeline stages would be highly desirable, because pipeline stages could be added at floorplanning to address logic timing issues and operating frequency limitations without initiating another round of design and layout. Such an architecture technology would allow the number of pipeline stages to be defined after the chip size is known, rather than before.

COREFRAME II is an SOC architecture technology that solves these problems because it supports on-chip interconnect implementations having pipelines of arbitrary length. COREFRAME II (CF2) and its predecessor COREFRAME I (CF1) are SOC technologies developed and owned by PALMCHIP Corporation, the assignee of this disclosure. The ability to implement pipelines of arbitrary length is a feature of CF2 that allows on-chip interconnects to be as high a speed as the silicon technology will allow, regardless of chip size. As used in this disclosure, the COREFRAME (CF) architecture refers to both the CF1 and CF2 versions of the architecture, while specific references to CF1 and/or CF2 refers to those specific versions of the architecture.

From a functional perspective, the connections between components or functional groups in a system can be loosely described as one of three general functional types: (1) peer-to-peer, in which each component or functional block initiates and/or receives communications directly to and from other functional blocks; (2) multi-master to a small number of targets, wherein a number of components or functional blocks initiate and/or receive communications from a handful of target components, who do not generally communicate with each other; and (3) single-master to a large number of targets, wherein a single component or functional block initiates and receives all communications from a number of target components. When all interconnects are symmetric, any of the three physical interconnect schemes shown in FIGS. 1A, 1B, and 1C work well for functional peer-to-peer systems. However, from a functional perspective, most on-chip systems are neither symmetric nor peer-to-peer systems, but rather, are more like a combination of multi-master to small number of targets (type 2 described above) and single master-to-multi-target (type 3 described above). Recall that system-on-chip devices generally implement multiple peripheral devices controlled by one or more processor devices (master-to-multi-target) and include multiple peripheral devices with DMA access to a shared memory (multi-master-to-target). Each functional connection type optimally calls for a different physical interconnection architecture, as described in more detail below.

Considering the FIGS. 1A, 1B, and 1C physical interconnect approaches from a functional perspective, assume that each figure is a multi-target SOC where the communication targets are labeled ‘1’ and the communication initiator is labeled ‘2’. In the FIG. 1A bussed implementation, the amount of physical wiring required is quite small; however, the wires themselves are very large - large enough that the capacitive loading of the wiring becomes a problem when there are many potential targets on the bus. The wires in the FIG. 1B point-to-point implementation have a lower overall capacitive loading, but when an initiator and its target are physically far from each other, the capacitive loading on that particular interconnect can become large as well, limiting performance. Moreover, as described above, a point-to-point interconnection architecture requires so many interconnect wires that layout can be quite difficult in large chips. The FIG. 1C interconnect fabric features more wires than the bussed implementation but fewer than the point-to-point implementation. In this implementation, signal speeds can be kept quite high because all wire lengths are relatively short, thus limiting capacitive loading. Moreover, throughput can be maintained by pipelining the links.

For large devices and/or devices having a large number of targets and initiators, the CF architecture uses the FIG. 1C fabric interconnection scheme, with pipeline stages added as required to tie all components together. Since SOCs are typically systems that utilize a functional interconnection combination of multi-master to small number of targets (type 2 described above) and single master-to-multi-target (type 3 described above), the CF solution implements two separate busses: the PalmBus, which connects components having a master-to-multi-target communication relationship, and the MBus, which connects components having a multi-master-to-target communication relationship. Each bus uses a synchronous protocol with full handshaking that enables any particular interconnect along the fabric to have an arbitrary number of pipeline stages, as required or desired to implement any specific design objective. The CF2 architecture's tolerance for the addition or subtraction of pipeline stages late in the design process eliminates the need for iterative design and layout steps as the SOC design approaches completion, potentially accelerating the design process.

### SUMMARY OF TH INVENTION

This invention discloses an SOC architecture that provides a dock-latency tolerant protocol for synchronous on-chip bus signals. The SOC includes at least a processor core and one or more peripherals that communicate on a first internal bus that carries signals from signal initiators to signal targets, wherein the signals have a latency tolerant protocol that enables an arbitrary number of pipeline stages between any signal initiator and any signal target. The SOC may also include a shared memory subsystem and DMA-type peripherals that communicate on a second internal bus that carries signals from signal initiators to signal targets, wherein the signals on the second internal bus also have a latency tolerant protocol that enables an arbitrary number of pipeline stages between any signal initiator and any signal target. All signals over both busses are point-to-point and registered and all transactions on both busses are handshaked. An arbitrary number of flip- flops, multiplexing routers, and/or decoding routers may be included between any signal initiator and any signal target on either bus, and may be added at any time during the design and layout of the SOC. The internal busses can have overlapping topologies where each bus can have a matrix fabric (or woven) topology, point-to-point topology, bridged topology, or bussed topology.

### DESCRIPTION OF THE DRAWINGS

The attached drawings help illustrate specific features of the invention and to further aid in understanding the invention. The following is a brief description of those drawings:

FIGS. 1A, 1B, and 1C illustrate different types of routing topologies in the context of an SOC with communications initiators and targets.

FIG. 2 shows a typical SOC implementation that illustrates the bus hierarchy of the CF architecture.

FIGS. 3A and 3B illustrate the CF topology of internal busses.

FIGS. 4A and 4B illustrate a point-to-point implementation topology of each bus that includes pipeline stages.

FIGS. 5A and 5B illustrate the CF bus topologies with a pipelined matrix interconnection fabric implementation.

FIG. 6 shows the overlapping topologies of the different busses of the CF architecture.

FIG. 7 illustrates a conventional low-speed implementation of inter-block interconnections.

FIG. 8 illustrates a registered interconnect between different blocks in an SOC.

FIG. 9 illustrates the CF registered and pipelined interconnect implementation.

FIG. 10 illustrates the expanded interconnect possibilities with the CF architecture, wherein two signal initiators address a single target.

FIG. 11 illustrates an embodiment of the present invention wherein a single initiator addresses multiple targets.

FIG. 12 illustrates the ability to combine different internal busses of the CF architecture together.

FIG. 13 illustrates a relative cross-section of the PalmBus for the timing diagrams in FIGS. 14 and 15.

FIG. 14 illustrates a PalmBus Write sequence using the present invention.

FIG. 15 illustrates a PalmBus Read sequence using the present invention.

FIG. 16 illustrates a relative cross-section of the MBus for the timing diagrams in FIGS. 17, 18, and 19.

FIG. 17 illustrates an MBus Multiple Burst Write sequence using this invention.

FIG. 18 illustrates an MBus Multiple Burst Read sequence using this invention.

FIG. 19 illustrates an MBus Multiple Burst Read sequence, where the transaction initiator has limited the burst rate, according to the present invention.

### DETAILED DESCRIPTION OF THE INVENTION

This invention discloses an SOC architecture that provides an arbitrary latency tolerant protocol for internal bus signals. This disclosure describes numerous specific details that include busses, signals, processors, and peripherals in order to provide a thorough understanding of the present invention. For example, the present invention describes SOC devices with memory controllers, DMA devices, and 10 devices. However, the practice of the present invention includes other peripheral devices, such as Ethernet controllers, memory devices, or other communication peripherals. One skilled in the art will appreciate that the present invention can be practiced without these specific details.

The CF architecture is a system-on-chip interconnect architecture that has significant advantages compared with other system interconnect schemes. By separating I/O control, data DMA, and CPU onto separate busses, the CF architecture avoids the bottleneck of the single system bus used in many systems. In addition, each bus uses a communications protocol that enables the use of an arbitrary number of pipeline stages on any particular interconnect, thus facilitating floorplanning, interconnect routing, and the layout process on a large chip.

The CF architecture includes several features that are designed to ease system integration without sacrificing performance: bus speed scalable to technology and design requirements; support for 256-, 128-, 64-, 32-, 16- and 8-bit peripherals; separate control and DMA interconnects; positive-edge clocking only; no tri-state signals or bus holders; hidden arbitration for DMA bus masters (no additional clock cycles needed for arbitration); a channel structure that reduces latency while enhancing reusability and portability because channels are designed with closer ties to the memory controller through the MBus; and finally, on-chip memory for the exclusive use of the processor is attached to the processor's native bus.

A number of features have been enhanced in version 2 of the CF architecture. For example, all transactions can be pipelined to enable very high clock rates; version 2 also uses a point-to-point registered interconnect scheme to achieve low capacitive loading and ease timing analysis. Finally, the CF2 busses are easily separable into links, which eases integration of functional components having different frequencies and widths.

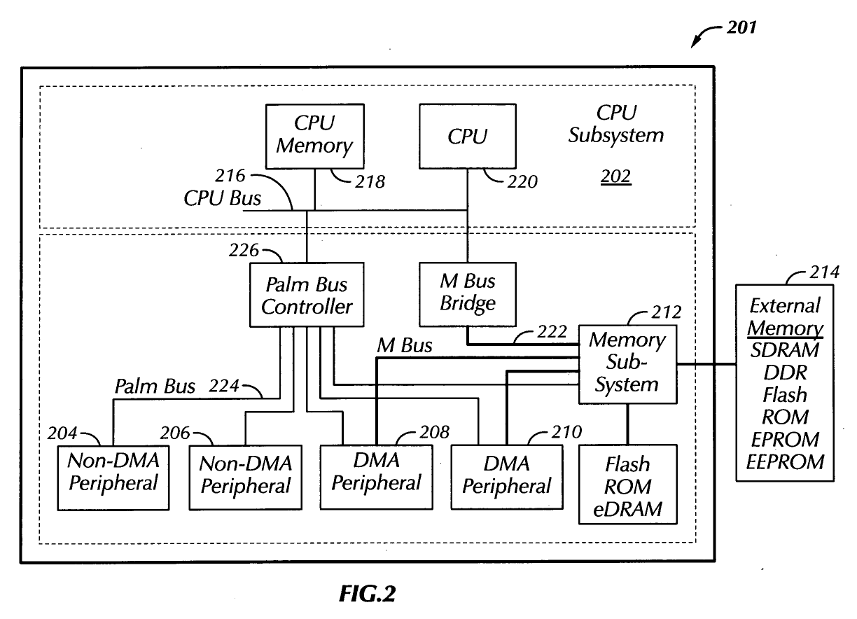

FIG. 2 shows a typical SOC implementation 201 that illustrates the bus hierarchy of the CF architecture. Typical SOC devices include a CPU Subsystem 202 (also referred to herein as a “processor core”) and various onboard peripheral devices 204, 206, 208, and 210 that may include peripherals that do not have direct memory access (non-DMA peripherals 204 and 206) and peripherals that can directly access memory (DMA peripherals 208 and 210). Those skilled in the art are quite familiar with the types of non- DMA peripherals and DMA peripherals that are commonly incorporated into typical SOCs. In typical SOC implementations, the CPU subsystem 202 contains its own set of busses 216 and peripherals 218 dedicated for exclusive use by the processor 220. SOCs may also have other busses not shown in FIG. 2, such as a peripheral integration bus. In the CF architecture, the CPU bus 216 and any other busses are external to the MBus 222 and PalmBus 224, which are the two primary CF busses. The CPU Bus 216 varies from one CF architecture-based system to another, depending on the most appropriate bus for the particular processor core 202.

The PalmBus 224 is the interface for communications between the CPU 220 and peripheral blocks 204, 206, 208, and 210. It is connected to the onboard Memory Controller 212, but is not ordinarily used to access memory. The PalmBus 224 is a master-slave interface, typically with a single master—the CPU core 202—which communicates on the PalmBus 224 through a PalmBus interface controller 226. All timings on the PalmBus 224 are synchronous with the bus clock.

The MBus 222 is the interface for communicating between one or more communications initiators and a shared target. Ordinarily, DMA peripherals 208 and 210 are the communications initiators, and the shared target is the Memory Controller 212. The MBus 222 is an arbitrated initiator-target interface. Each initiator arbitrates for access to the target and once transfer is granted, the target controls data flow. All MBus signals are synchronous to a single clock; however, any two links may use different clocks if the pipeline stage between the two provides synchronization.

To ease integration, DMA channels are often implemented which abstract the memory-related details from the peripheral components. This allows the implementation of a simple FlFOlike interface between DMA channels and DMA peripherals. This bus is optional, and not included within the scope of the CF architecture, and not shown in FIG. 2.

The two CF busses, the PalmBus and the MBus, are typically implemented with overlapped topologies. The PalmBus generally has a single initiator (normally a processor) and many targets (normally peripheral blocks). The MBus typically has multiple initiators and a single target. The MBus initiators are primarily DMA devices and the target a memory controller.

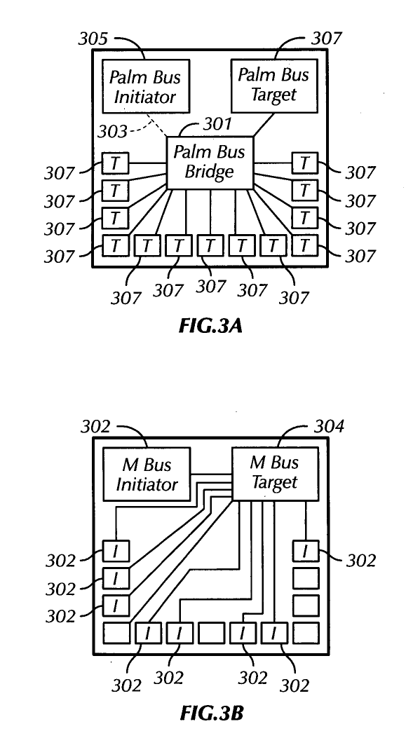

FIGS. 3A and 3B illustrate the PalmBus topology and the MBus topology, respectively. Each solid line between blocks represents one instance of a PalmBus or MBus interconnect. FIG. 3A shows a bridge 301 to simplify the integration of the PalmBus links; the interface between the PalmBus initiator 305 and the bridge 301 is shown with a dotted line 303. In FIG. 3A, the communications initiator is designated 305; communications targets are designated as 307. In FIG. 3B, the communications initiators are designated as 302 and the target as 304. For simplicity, the bus topology on both of these figures is shown as point-to-point.

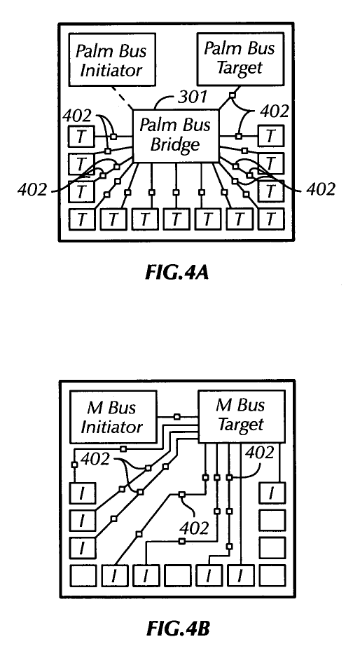

FIGS. 4A and 4B illustrate a point-to-point implementation topology of each bus that includes pipeline stages 402. As described above, the CF architecture is designed for simple integration into very large high-speed devices. Because components interconnected with the PalmBus and MBus may be located far from each other on the chip, pipeline stages may be required in some of the links. The ability to arbitrarily pipeline the PalmBus and MBus greatly eases integration of large devices by allowing the chip to be re-timed late in layout without affecting the timing closure of individual components.

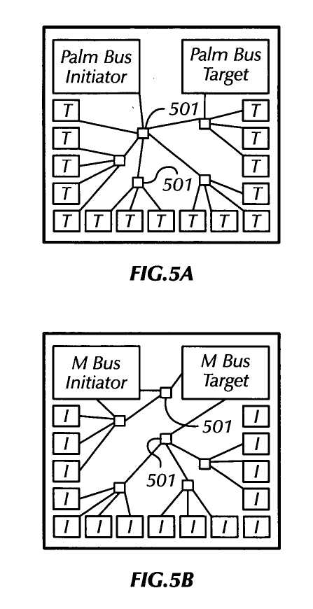

FIGS. 5A and 5B illustrate the CF bus topologies with a pipelined matrix interconnection fabric implementation. Just as pipeline stages can be added and subtracted to ease design and integration, the architecture supports the addition of pipelined multiplexers, splitters, and decoders, shown generically as item 501 in FIGS. 5A and 5B, to combine and distribute busses. This feature simplifies the layout of complex chips because it enables the number of routed signals to be reduced. If either bus is sufficiently multiplexed and split, the bus bridge 301 shown in FIGS. 3A and 4A can easily be eliminated because there is only a single link from the initiator. By ensuring that each multiplexer 501 is also a pipeline stage, timing closure can easily be achieved while simultaneously improving routability of the chip.

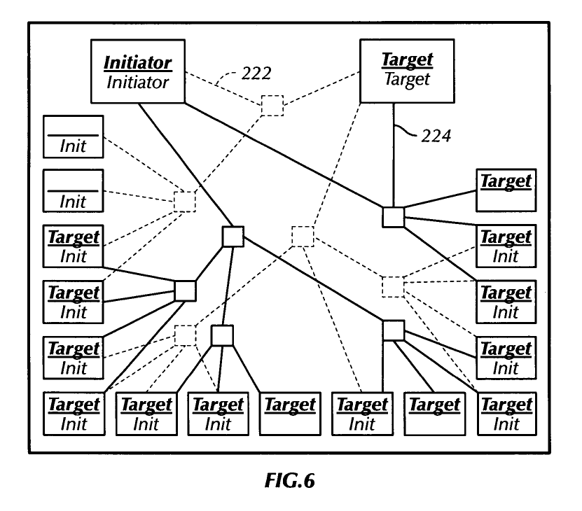

FIG. 6 shows the two busses, the PalmBus 224 and the MBus 222, in a true overlapping topology arrangement, such as would be the case in a true SOC utilizing the CF architecture.

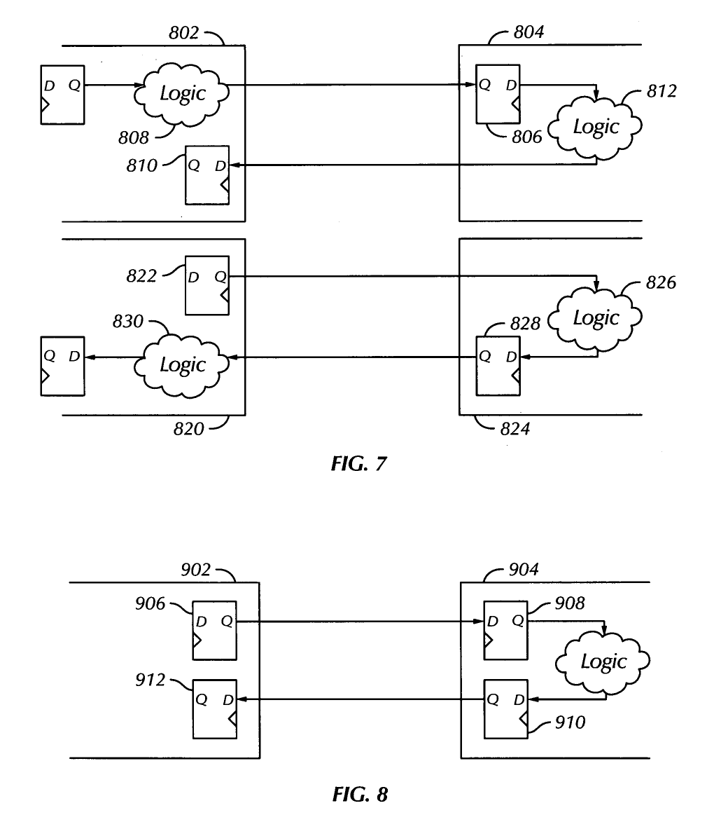

FIG. 7 illustrates a conventional low-speed implementation of inter-block interconnections. In FIG. 7, flip-flop 806 in logic block 804 receives a signal directly from the logic 808 within logic block 802, performs its logic function using internal logic 812, and then returns a signal directly to flip-flop 810 in logic block 802. Similarly, flip-flop 822 in logic block 820 sends a signal directly to logic 826 in logic block 824. Some time later, after the signal propagates through logic 826 to flip-flop 828, it is sent back to logic 830 in logic block 822. In other words, in a conventional low-speed interconnect implementation, logic blocks are often interconnected such that either incoming or outgoing signals connect directly to the functional logic within a logic block. When logic blocks that are interconnected in this manner are relatively distant from each other, this implementation can be difficult to floorplan and implement in layout, because signal timing becomes critical.

FIG. 8 illustrates an interconnect implementation that is much friendlier to layout in large devices. In FIG. 8, the signals between logic blocks are not directly connected to functional logic within the logic blocks 902 and 904. Instead, the interconnecting signals are sent from and received by flip-flops 906, 908, 910, and 912. This implementation enables the interconnecting signals to be registered on block inputs and outputs, which simplifies the design and layout because signal timing becomes much more predictable than the interconnect implementation shown in FIG. 7. The interconnecting signals between logic blocks 902 and 904 in FIG. 8 are said to be “registered signals.”

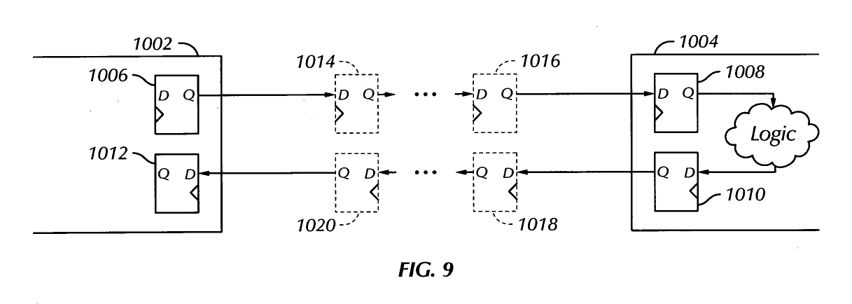

FIG. 9 illustrates the CF2 interconnect implementation, wherein the interconnecting signals between logic blocks 1002 and 1004 are registered interconnects, meaning that they originate and terminate to flip-flops 1006, 1008, 1010, and 1012 rather than to logic within blocks 1002 and 1004. In addition, the interconnecting signals have been arbitrarily pipelined, meaning that some number of flip-flops (indicated by flip-flops 1014, 1016, 1018, and 1020) have been added to the signal path between logic blocks 1002 and 1004. This implementation allows full registering of all signals, simplifying device floorplanning and timing closure. Moreover, the ability to arbitrarily pipeline any PalmBus or MBus link (meaning the ability to add an arbitrary number of flip-flops in any interconnection signal path) frees the designers to re-floor plan late in layout without having to re-time the entire chip. As explained in further detail below, the CF2 architecture supports the addition of an arbitrary number of pipeline stages at any point in the design process (even late in layout) because the CF2 architecture approach excludes next-cycle dependencies between logic blocks. In SOCs implemented in the CF2 architecture and protocol, logic events are not required to occur within a fixed number of clock cycles of each other. After any event occurs, the next event that must occur as part of the protocol may occur any number of clock cycles later.

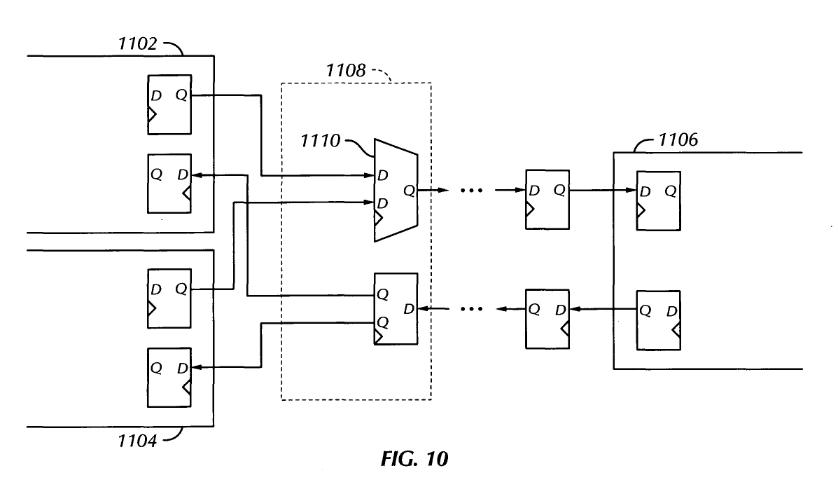

The CF2 architecture enables a flexible bus topology without compromising clock speed or layout. For example, FIG. 10 shows a pipelined multiplexer/router interconnect scheme, which allows a greater number of initiators to address a single target while reducing the number of interconnects required. In FIG. 10, blocks 1102 and 1104 are both signal initiators for target block 1106, but the interconnect is routed through multiplexer 1110. On the downstream side of multiplexer 1110, only one interconnect is required. In this implementation, while the number of links increases (6 interconnecting links rather than 4), the links are shorter, so they are easier to accommodate in layout than a smaller number of larger links. Multiplexer/router 1108 is simply another pipeline stage.

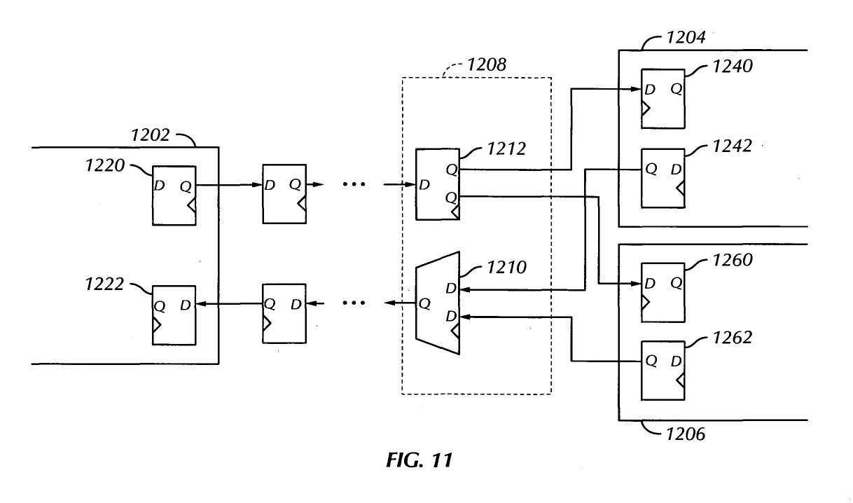

Similarly, as shown in FIG. 11, a single initiator may address multiple targets through the implementation of pipelined decoder/router blocks. In FIG. 11, signal initiator 1220 in logic block 1202 is addressing both targets 1240 in logic block 1204 and 1260 in logic block 1206 through router 1212. Likewise, signal initiators 1242 in logic block 1204 and 1262 in logic block 1206 are addressing signal target 1222 in logic block 1202 through decoder 1210 in router/decoder block 1208.

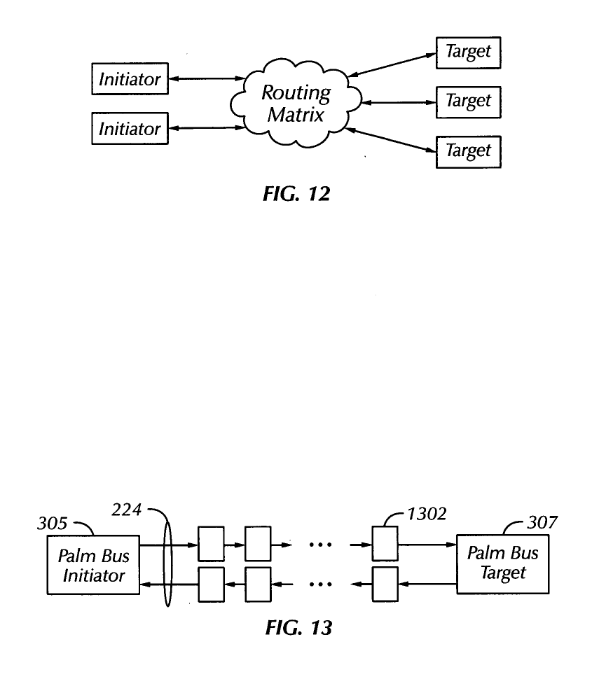

The use of pipelined registers, multiplexers, routers, and decoders routers can be combined to suit a wide variety of devices, easing the physical implementation of the device while maintaining performance. FIG. 12 illustrates the ability to combine the different internal busses of the CF architecture together.

Those skilled in the art will appreciate that a conventional design utilizing an interconnect approach as shown in FIG. 7 cannot be arbitrarily pipelined if there are dependencies from one clock cycle to the next clock cycle, or from one clock cycle to a fixed clock cycle thereafter. Using the well-known PCI bus protocol as an example, when the bus master asserts the FRAME# signal, the master must see the TRDY# signal as either ‘1’ or ‘0’ in the next clock cycle. Thereafter, a specific action is performed, based on the value received by the bus master. If the FRAME# signal were pipelined, the bus slave would not see the current state of the FRAME# signal until one clock cycle later, and could not issue a response until after the master has begun to act on the old state of TRDY#.

The CF2 protocol solves this problem defining only one active state for each response signal. The initiator on the interface cannot proceed until receiving a positive response from the target (a “handshake”), regardless of the delay between an action and the response. A design cannot be easily arbitrarily pipelined if the protocol is not fully handshaked, meaning that every communications initiator must receive a response from the target before any communication can proceed. If any portion of the protocol is not fully handshaked, an overflow condition can occur, where commands or data issued by one component will not be properly received by the target component. An overflow either causes a breakdown of the protocol, or requires re-transmission of an arbitrary number of commands. Handling either of these conditions requires an excessive amount of design or on-chip resources. The CF2 protocol avoids this issue by requiring full handshakes for every communication, on both the PalmBus and the MBus.

The PalmBus protocol requires that an initiator issuing a read or write strobe (pb_bik_re or pb_blk_we, respectively) must receive a ready strobe (pb_blk_rdy) before it issues any subsequent read or write strobe. Similarly, the MBus protocol requires that an initiator issuing an address strobe, mb_bik_astb, first receive an address acknowledge response, mb_bik_aack, before another address strobe can be issued.

The responses are pulsed signals that must be received before the initiator can perform any subsequent action. All data is validated exclusively with a strobe; thus, the pipeline depths can be different for different type of data (address, write data and read data). The recipient captures the data when the strobe is received.

Those skilled in the art will appreciate, after reading this specification and/or practicing the present invention, that the CF2 architecture and protocol implementation includes a number of highly desirable features. It is easy to implement different bus widths between each pipeline stage, data transmission will never stall, and data streams can be multiplexed.

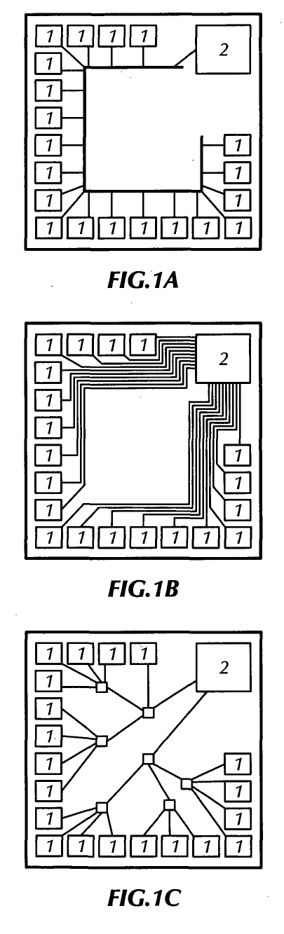

PalmBus Signal Protocol. The PalmBus signals, which are point-to-point between the initiator and a specific target, are shown in the Table 1 below. In the context of specific signals on the PalmBus, the phrase “point-to-point” is used in a functional sense, meaning that a signal originates at a specific point (the “initiator”) and is intended for and ultimately terminates to a different specific point (the “target”). In a specific SOC utilizing the architecture of the present invention, these point-to-point signals may be physically carried on a PalmBus implemented using any of the various physical topologies shown in FIGS. 1A, 1B, or 1C.

The character field ‘mst_’ and ‘blk_’ is used to distinguish the nature of the signal. Those that include ‘mst_’ are point-to-point between the initiator and an application-specific system component, such as a bus controller. With the exception of the clock, all signals that include ‘blk_’ are point-to-point between an initiator and a target. The implementation of the clock is application-specific, but all signals labeled ‘blk_’ in Table 1 are synchronous to the pb_blk_clk signal. In a specific design, each block's identifier replaces the characters ‘blk’ in the signal name. For example, an interrupt controller block identified as “intr” sending a “Ready Acknowledge” signal to the PalmBus controller would send the pb_intr_rdy signal. The Write Enable signal that the PalmBus controller would send to a timer block identified as ‘tmr_’ would be identified as pb_tmr_we. All PalmBus signals are prefixed by ‘pb_’ to indicate that they are specific to the PalmBus.

TABLE 1
PalmBus Signal Summary

| SIGNAL | DIRECTION | DESCRIPTION |
|---|---|---|
| System Signals | | |
| pb_blk_clk | | PalmBus clock; 1-bit signal; may |
| | | be generated and distributed by the |
| | | PalmBus Controller, or may be |
| | | generated by a clock control |
| | | module and distributed to the |
| | | PalmBus Controller and other |
| | | modules. |
| pb_mst_req | Initiator | Bus Request. 1-bit arbitration |
| | to System | signal for a multi-master system, |
| | | not required in single master |
| | | systems. Asserted when a PalmBus |
| | | master wishes to perform a read or |
| | | write and held asserted through the |
| | | end of the read or write. |
| pb_mst_gnt | System Controller | Bus Grant. 1-bit signal indicating |
| | to pb_mst_req | whether the PalmBus can be |
| | initiator | accessed in a multi-master system. |
| | | Can be fed high (true) in single |
| | | master systems; can be asserted |
| | | without a prior pb_mst_req |
| | | assertion. |
| Address Signals | | |
| pb_blk_addr | Controller to | Address of a memory-mapped |
| | Target Block | memory location (memory, |
| | | register, FIFO, etc.) to write or |
| | | read. Width is application-specific. |
| | | Valid on the rising edge of |
| | | pb_blk_clk when a |
| | | pb_blk_we or pb_blk_re is ‘1’. |
| | | Must remain stable from the |
| | | beginning of a read or write access |
| | | until pb_blk_rdy is asserted. |
| Data Signals | | |
| pb_blk_rdata | Target block | Read data to CPU. Application- |
| | to Controller | specific width (usually a multiple |
| | | of 8 bits). Valid on the rising edge |
| | | of pb_blk_clk when pb_blk_rdy |
| | | is ‘1’. |
| pb_blk_re | Controller to | Read enable. 1-bit (optionally, |
| | Target Block | n-bit) block-unique signal used to |
| | | validate a read access. Launched |
| | | on the rising edge of pb_blk_clk |
| | | and is valid until the next rising |
| | | edge of pb_blk_clk. In some |
| | | embodiments, requires the |
| | | assertion of pb_blk_gnt within |
| | | 1-3 (or user-selected number) prior |
| | | clock cycles. (See discussion in |
| | | text.) |
| pb_blk_wdata | Controller to | Write data from CPU. Application- |
| | Target Block | specific width (usually a multiple |
| | | of 8 bits). Valid on the rising edge |
| | | of pb_blk_clk when a |
| | | pb_blk_bsel and the |
| | | corresponding pb_blk_we is ‘1’. |
| | | Must remain stable from the |
| | | beginning of the write access until |
| | | pb_blk_rdy is asserted. |
| pb_blk_bsel | Controller to | Byte selects for write data. ⅛ of |
| | Target Block | the pb_blk_wdata bit width. |
| | | Each bit of pb_blk_bsel |
| | | corresponds to one byte of |
| | | pb_blk_wdata, with bit 0 |
| | | corresponding to bits 0 through 7 |
| | | of pb_blk_wdata. Allows the |
| | | masking of specific bytes during |
| | | writes to the target. All bits must |
| | | be ‘1’s during PalmBus read |
| | | operations. Asserted with or before |
| | | the assertion of pb_blk_we |
| | | during a write. Must remain stable |
| | | from the beginning of a read or |
| | | write access until pb_blk_rdy is |
| | | asserted. (For enhanced |
| | | operability, it is recommended but |
| | | not required that all bit |
| | | combinations asserted on |
| | | pb_blk_bsel can be translated |
| | | to a standard 8-bit, 16-bit, 32-bit, |
| | | etc. transfer.) |
| pb_blk_we | Controller to | Write enable. 1-bit, block-unique |
| | Target Block | signal used to validate a write |
| | | access. Launched on the rising |
| | | edge of pb_blk_clk and is valid |
| | | until the next rising edge of |
| | | pb_blk_clk. |
| Flow | | |
| Control Signals | | |
| pb_blk_rdy | Block to | Ready Acknowledge. 1-bit signal |
| | Controller | asserted for exactly one cycle to |
| | | end read or write accesses, |
| | | indicating access is complete. The |
| | | PalmBus Controller asserts a CPU |
| | | wait signal when it decodes an |
| | | access addressing a PalmBus |
| | | target. The CPU wait signal |
| | | remains asserted until the |
| | | pb_blk_rdy is asserted |
| | | indicating that access is complete. |

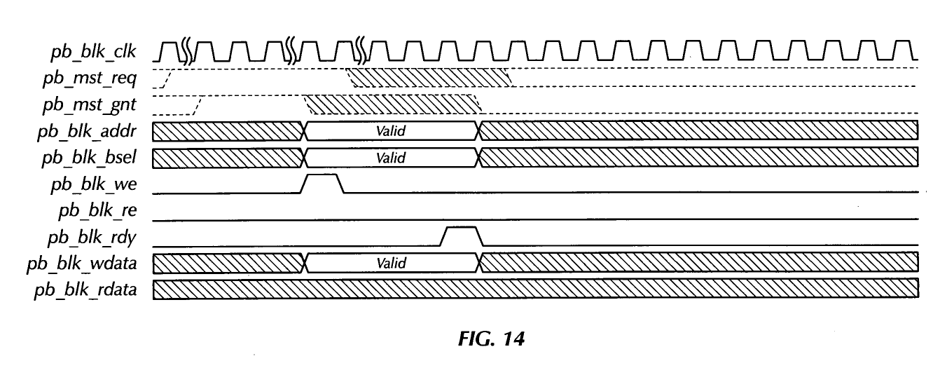

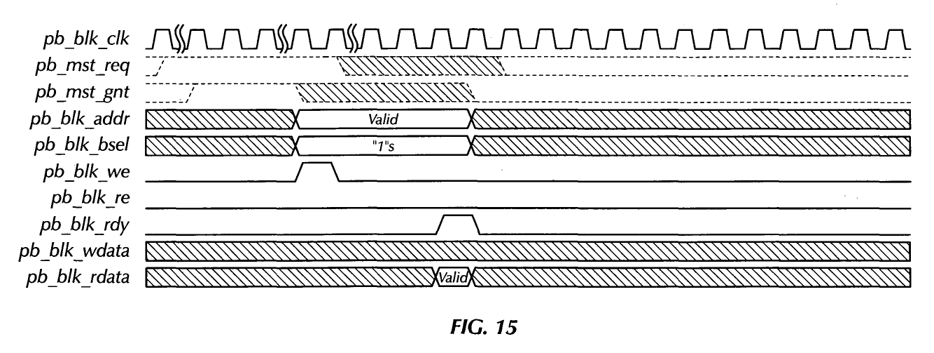

FIG. 13 illustrates a relative cross-section of the PalmBus 224 for the example timing diagrams in FIGS. 14 and 15. For illustrative purposes, FIG. 13 includes a generic PalmBus initiator 305, a generic PalmBus target 307, and generic pipeline stages 1302 which may be simple flip-flops as shown in FIGS. 4A and 9, or multiplexing or decoding routers as shown in FIGS. 5A, 10, and 11. The purpose of the timing diagrams shown in FIGS. 14 and 15 is to illustrate the PalmBus bus protocol. Any relative timing of signals with respect to each other is coincidental, unless otherwise specified. Since the PalmBus can be pipelined at any point, with an arbitrary number of pipeline stages between a signal initiator and target, signals will look different at any given time and cross section, depending on the cross section chosen. All waveforms in FIGS. 14 and 15 are from the reference point of the PalmBus master interface. Also, the pb_blk_clk signal is the reference clock for all initiator/target pairs shown in the figures, however, it may or may not be the global clock or the clock for any other PalmBus initiator/target pairs.

FIG. 14 illustrates a PaimBus write sequence according to the protocol of the present invention. pb_blk_req is an optional arbitration signal that is only useful in multi-master systems. In a multi-master system, the signal initiator asserts the pb_blk_req signal to request access and control over the PalmBus. As shown in FIG. 15, the pb_blk_req signal must be asserted before and through the cycle when pb_blk_we is asserted. Thereafter, the bus controller asserts the pb_mst_gnt signal to grant the signal initiator access and control over the PalmBus. In one embodiment of the present invention, the pb_mst_gnt signal must be high at least once within 1 to 3 cycles before the signal initiator asserts the write enable signal, pb_blk_we, to the target(s).

The arbitration signals pb_blk_req and pb_mst_gnt are provided as a convenience to the designer. Designers are very familiar with request/grant handshakes; using these signals can facilitate the migration of an existing design to the CF2 interconnect. In another embodiment, PalmBus arbitration may be performed via the interaction of the ready acknowledge signal pb_blk_rdy and either the write enable signal pb_blk_we or the read enable signal pb_blk_re. In this embodiment, pb_mst_gnt is tied ‘true’ so there is no cycle time limit for the assertion of either the write or read enable signals, and consequently, no pipeline depth limitation between the bus controller and the signal initiator(s). If the system is a multi-master system and pipeline depth flexibility is of lesser concern, the designer may choose to use the arbitration signals pb_blk_req and pb_mst_gnt, thus fixing the maximum pipeline depth between the bus controller and the signal initiator(s). A depth of ‘3’ is recommended as a reasonable depth, meaning that the pb_mst_gnt signal must be high at least once within 1 to 3 cycles before the signal initiator asserts the enable signal, but practitioners of the present invention can alter the maximum pipeline depth to suit the design in question.

Returning to FIG. 14, pb_blk_addr, pb_blk_bsel, and pb_blk_wdata must all be valid before the rising edge of pb_blk_clk when pb_blk_we is asserted. pb_bik_addr, pb_bik_bsel and pb_blk_wdata must stay asserted or valid through the end of the clock cycle in which the target device asserts pb_blk_rdy.

FIG. 15 illustrates a PalmBus read sequence according to the protocol of the present invention. Again, this embodiment is assumed to be a multi-master system so the optional arbitration signals pb_blk_req and pb_mst_gnt are used. As described above, the signal initiator asserts the pb_blk_req to request access and control over the PalmBus. As described above, the pb_blk_req must be asserted before and through the cycle when pb_blk_re is asserted, and the pb_mst_gnt must be high at least once within 1 to 3 cycles before pb_blk_re is asserted. pb_blk_addr and pb_blk_bsel must be valid before the rising edge of pb_blk_clk when pb_blk_re is asserted. (The valid state of pb_blk_bsel during reads is high (all bits of bus high)). pb_blk_addr and pb_blk_bsel must remain valid through the end of the clock cycle where pb_blk_rdy is asserted. Finally, pb_blk_rdata must be driven valid by the target device through the end of the clock cycle where pb_blk_rdy is asserted by the target device. As described above, in an alternative embodiment, pb_mst_gnt is tied ‘true’ and PalmBus arbitration is performed via the interaction of pb_blk_rdy and pb_bik_re, so that there is no cycle time limit for the assertion of the read enable signal, and no pipeline depth limitation between the bus controller and the signal initiator(s).

MBus Signal Protocol. The MBus signals, which are point-to-point between the target and an initiator, are shown in Table 2 below. As described above in connection with the point-to-point signals on the PalmBus, the phrase “point-to-point” is used here in a functional sense, meaning that a signal originates at a specific point (the “initiator”) and is intended for and ultimately terminates to a different specific point (the “target”). In a specific SOC utilizing the architecture of the present invention, these point-to-point signals may be physically carried on an MBus implemented using any of the various physical topologies shown in FIGS. 1A, 1B, or 1C.

As described in the context of the PalmBus signals, the character field ‘blk_’ is used to distinguish the nature of the signal. Like the PalmBus protocol, in a specific design each block's identifier replaces the characters ‘blk’ in the signal name, except for the clock signal. For example, ‘dma_’ would replace ‘blk_’ for a DMA controller, and ‘aud_’ would designate an audio FIFO. All MBus signals are prefixed by ‘mb_’ to indicate that they belong to the MBus.

TABLE 2
MBus Signal Summary

| Signal | Direction | Description |
|---|---|---|
| System Signals | | |
| mb_blk_clk | — | MBus clock for block. All mb signals |
| | | are synchronous, launched, and |
| | | captured at one of its rising edges. |
| | | Can be a system-wide clock; |
| | | optionally, each Initiator/Target |
| | | segment may have its own clock |
| | | domain, clock frequency, and/or |
| | | clock power management. |
| mb_blk_req | Initiator | MBus Target access request. 1-bit |
| | to Target | signal asserted to initiate a |
| | | transaction. For maximum |
| | | compatibility it should not be held |
| | | continuously asserted if no |
| | | transactions will be initiated. |
| mb_blk_ardy | Target to | MBus Target access grant. Optional |
| | Initiator | 1-bit signal indicating MBus |
| | | readiness for address strobe. Can be |
| | | tied true if mb_blk_astb/ |
| | | mb_blk_aack arbitrate MBus. |
| Address Signals | | |
| mb_blk_addr | Initiator | Byte-level address of pending |
| | to Target | transfer/first datum if pending |
| | | transfer is a burst. Lower bits |
| | | corresponding to byte lanes should |
| | | be driven low (‘0’) by the initiator |
| | | and ignored by the target. |
| mb_blk_astb | Initiator | Address/command valid strobe. |
| | to Target | Issued by the initiator to indicate that |
| | | the address is valid, and that the |
| | | target may capture |
| | | mb_blk_astb_tag, mb_blk_addr, |
| | | mb_blk_dir, mb_blk_blen and |
| | | mb_blk_brate. In an embodiment |
| | | where mb_blk_ardy is not tied true, |
| | | mb_blk_astb may not be asserted |
| | | more than 7 clock cycles after |
| | | mb_blk_ardy is negated. (See |
| | | discussion in text.) |
| mb_blk_astb_tag | Initiator | Address/command valid strobe |
| | to Target | sequence tag. Optional-width signal |
| | | that sequentially tags transaction |
| | | requests. Toggles between ‘1’ and ‘0’ |
| | | if it is a single bit. If pipelined, |
| | | overlapped, split, or if out-of-order |
| | | transactions are supported, |
| | | mb_blk_astb_tag must contain |
| | | enough bits to enable every |
| | | outstanding transaction to have its |
| | | own unique tag. |
| mb_blk_aack | Target to | Address/command valid |
| | Initiator | acknowledge. Acknowledges that an |
| | | address issued by an mb_blk_astb |
| | | has been captured by the target, and |
| | | that the initiator is free to update the |
| | | address and issue another |
| | | mb_blk_astb. |
| mb_blk_aack_tag | Target to | Address/command valid acknowledge |
| | Initiator | sequence tag. Sequentially tags |
| | | transaction acknowledge strobes and |
| | | optionally includes application- |
| | | specific coherency information from |
| | | the target memory. If pipelined, |
| | | overlapped, split, or if out- |
| | | of-order transactions are supported, |
| | | mb_blk_aack_tag must contain |
| | | enough bits that every outstanding |
| | | transaction has its own unique tag. |
| | | mb_blk_aack_tag must contain |
| | | information carried by the |
| | | corresponding mb_blk_astb_tag; |
| | | for example, for the case of a 1-bit |
| | | tag, mb_blk_aack_tag is the same |
| | | value as the corresponding |
| | | mb_blk_astb_tag. Note that if |
| | | mb_blk_aerr is implemented, |
| | | mb_blk_aack_tag must also be |
| | | valid at its assertion. |
| Data Signals | | |
| mb_blk_wrdy | Target to | MBus Target write ready. 1-bit signal |
| | Initiator | asserted to indicate readiness to |
| | | receive write data; asserted once for |
| | | every word of data to be transmitted |
| | | in the current cycle; may not occur in |
| | | contiguous clock cycles. Must be |
| | | preceded by a valid address cycle. |
| mb_blk_wstb | Initiator | MBus write data cycle valid strobe. |
| | to Target | 1-bit functional wrap-back of |
| | | mb_blk_wrdy with the same relative |
| | | timing as mb_blk_wrdy. Cannot |
| | | occur before corresponding |
| | | mb_blk_wrdy assertion. |
| mb_blk_wlstb | Initiator | MBus Target write data last cycle |
| | to Target | indicator. Optional strobe indicating |
| | | that the current strobe of the burst is |
| | | the last strobe of the write burst. |
| mb_blk_wlack | Target to | MBus Target write last strobe |
| | Initiator | acknowledge. Optional strobe |
| | | indicating that the data received with |
| | | the mb_blk_wlstb has been |
| | | processed. Can be used to determine |
| | | final write status when write data is |
| | | posted. This signal is asserted |
| | | concurrent with or later than |
| | | mb_blk_wlstb. When concurrent |
| | | with mb_blk_wlstb it can be |
| | | assumed that the write data is not |
| | | posted. |
| mb_blk_wdata | Initiator | Write data. Application-specific |
| | to Target | signal width (usually a multiple of 8 |
| | | bits and usually a power of 2). Valid |
| | | only in a cycle where mb_blk_wstb |
| | | is asserted and when the |
| | | corresponding mb_blk_bsel bits |
| | | are ‘1’. |
| mb_blk_bsel | Initiator | Write data byte selects. ⅛ of the |
| | to Target | mb_blk_wdata bit width. Each bit of |
| | | mb_blk_bsel corresponds to one |
| | | byte of mb_blk_wdata with bit 0 |
| | | corresponding to bits 0 through 7 of |
| | | mb_blk_wdata. Allows the masking |
| | | of specific bytes during writes to the |
| | | target. All bits must be ‘1’s during |
| | | MBus read operations. Asserted with |
| | | or before the assertion of |
| | | mb_blk_we during a write. Must |
| | | remain stable from the beginning of a |
| | | read or write access until |
| | | mb_blk_rdy is asserted. |
| | | For enhanced operability, it is |
| | | recommended but not required that |
| | | all bit combinations asserted on |
| | | mb_blk_bsel can be translated to a |
| | | standard 8-bit, 16-bit, 32-bit, etc. |
| | | transfer. |
| mb_blk_rstb | Target to | Read data valid strobe. 1-bit strobe |
| | Initiator | asserted by target to strobe read data |
| | | to the initiator. Must be preceded by |
| | | a valid address cycle. |
| mb_blk_rlstb | Target to | Last read data cycle indicator. |
| | Initiator | Indicates that the current strobe of the |
| | | burst is the last strobe of the read |
| | | burst. Timing follows mb_blk_rstb, |
| | | except that it is only asserted for the |
| | | last strobe of the burst. |
| mb_blk_rdata | Target to | Read data. Width is application- |
| | Initiator | specific, usually 8-bit multiples/ |
| | | power of 2. Contents are valid only in |
| | | a cycle where mb_blk_rstb is |
| | | asserted. |
| Transaction | | |
| Information Signals | | |
| mb_blk_blen | Initiator | 4-bit signal encoding burst number in |
| | to Target | powers of two up to 16 bursts (0 = |
| | | single non-burst; 1 = 2 bursts, 2 = |
| | | 4 bursts, etc. up to 16 bursts) |
| mb_blk_brate | Initiator | 4-bit signal encoding peak rate of |
| | to Target | data transfer in powers of two; (0 = |
| | | data can be sent or received every |
| | | clock cycle; 1 = every other clock |
| | | cycle; 2 = every 4 clock cycles; 3 = |
| | | every 8 clock cycles, etc. up to every |
| | | 16 clock cycles). |
| mb_blk_dir | Initiator | 1-bit signal encoding transfer type: |
| | to Target | 1 = MBus Target write; 0 = MBus |
| | | Target read. |
| Data Integrity | | |
| Signals (Optional) | | |
| mb_blk_aerr | Target to | Address/command valid error |
| | Initiator | acknowledge. Optionally sent in |
| | | place of mb_blk_aack. |
| | | Acknowledges that an address issued |
| | | by a mb_blk_astb has been captured |
| | | by the target but will be ignored |
| | | (address/command invalid or target |
| | | busy). Initiator may change address/ |
| | | issue another mb_blk_astb once |
| | | this signal has been issued. |
| mb_bik_wdatap | Initiator | 1-bit optional write data parity, CRC, |
| | to Target | or ECC signal transmitted with write |
| | | data for protection. Recommended |
| | | target response in case of write error |
| | | is to strobe mb_blk_terr presenting |
| | | the corresponding tag information on |
| | | mb_blk_terr tag if implemented. |
| mb_blk_rdatap | Target to | 1-bit optional read data parity, CRC, |
| | Initiator | or ECC signal transmitted with read |
| | | data for protection. Recommended |
| | | initiator response in case of read |
| | | error if the target is capable of retry |
| | | is to strobe mb_blk_ierr, |
| | | presenting the corresponding tag |
| | | information on mb_blk_ierr_tag. |
| mb_blk_ierr | Initiator | Application-specific optional |
| | to Target | initiator-signaled read error (e.g. bad |
| | | read data parity). See |
| | | mb_blk_rdatap. Can be multi-bit |
| | | if error type information is |
| | | to be encoded. If implemented, the |
| | | transaction that generated the error |
| | | should be indicated with the |
| | | mb_blk_ierr_tag bus. |
| mb_blk_terr | Target to | Application-specific optional target- |
| | Initiator | signaled write error (e.g. bad write |
| | | data parity). See mb_blk_wdatap. |
| | | Can be multi-bit if error type |
| | | information is to be encoded. If |
| | | implemented, the transaction that |
| | | generated the error should be |
| | | indicated with the mb_blk_terr_tag |
| | | bus. |
| mb_blk_rstb_tag | Target to | Read data valid strobe sequence tag |
| | Initiator | (optional) If 1-bit, toggles for each |
| | | read data strobe. If pipelined, |
| | | overlapped, split, or out-of-order |
| | | transactions are supported, must be |
| | | sufficiently wide to uniquely tag |
| | | every outstanding transaction; value |
| | | must match the value of |
| | | corresponding mb_blk_astb_tag. |
| mb_blk_wrdy_tag | Target to | MBus Target write ready sequence |
| | Initiator | tag (optional) If 1-bit, toggles for |
| | | each write data ready strobe. If |
| | | pipelined, overlapped, split, or out- |
| | | of-order transactions are supported, |
| | | must be sufficiently wide to uniquely |
| | | tag every outstanding transaction; |
| | | value must match the value of |
| | | corresponding mb_blk_astb_tag. |
| mb_blk_wstb_tag | Initiator | MBus Target write data strobe |
| | to Target | sequence tag (optional). If 1-bit, |
| | | toggles for each write data strobe. If |
| | | pipelined, overlapped, split, or out- |
| | | of-order transactions are supported, |
| | | must be sufficiently wide to uniquely |
| | | tag every outstanding transaction; |
| | | value must match the value of |
| | | corresponding mb_blk_astb_tag. |
| mb_blk_wlack_tag | Target to | MBus Target write acknowledge |
| | Initiator | sequence tag. (optional) If 1-bit, |
| | | toggles for each write last data |
| | | acknowledge strobe. If pipelined, |
| | | overlapped, split, or out-of-order |
| | | transactions are supported, must be |
| | | sufficiently wide to uniquely |
| | | tag every outstanding transaction; |
| | | value must match the value of |
| | | corresponding mb_blk_astb_tag. |
| mb_blk_ierr_tag | Initiator | Optional initiator error sequence tag. |
| | to Target | Tags an initiator error indication. |
| | | Value must match the value of |
| | | corresponding mb_blk_astb_tag to |
| | | match error to specific transaction. |
| mb_blk_terr_tag | Target to | Optional target error sequence tag. |
| | Initiator | Tags a target error indication. Value |
| | | must match the value of |
| | | corresponding mb_blk_astb_tag to |
| | | match error to specific transaction. |

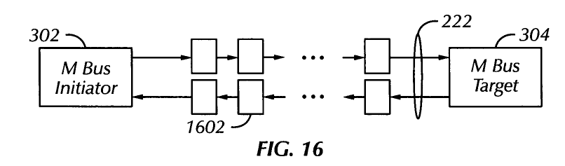

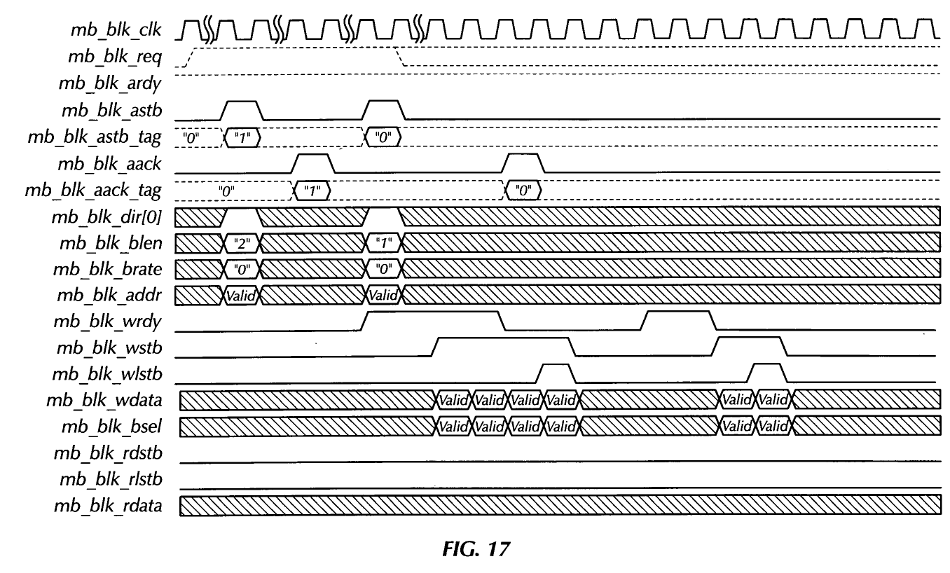

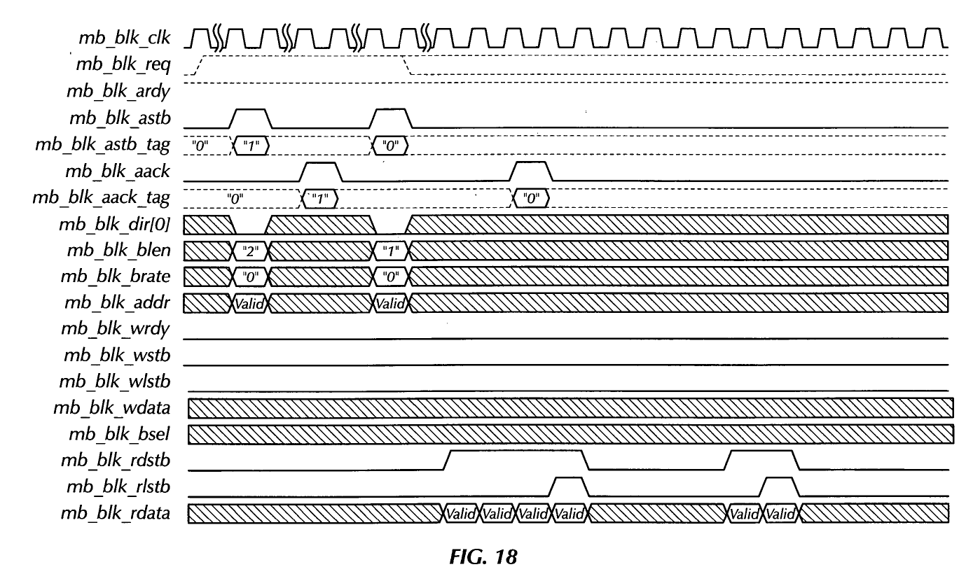

FIG. 16 illustrates a relative cross-section of the MBus for the example timing diagrams in FIGS. 17, 18 and 19. For illustrative purposes, FIG. 16 includes a generic MBus initiator 302, a generic MBus target 304, and generic pipeline stages 1602 which may be simple flip-flops as shown in FIGS. 4B and 9, or multiplexing or decoding routers as shown in FIGS. 5B, 10, and 11. As with the example timing diagrams of FIGS. 14 and 15 relative to the PalmBus, the purpose of the timing diagrams shown in FIGS. 17, 18, and 19 is to illustrate the MBus bus protocol. Again, any relative timing of signals with respect to each other is coincidental, unless otherwise specified. And, since the MBus can be pipelined at any point, with an arbitrary number of pipeline stages between a signal initiator and target, signals will look different at any given time and cross section, depending on the cross section chosen. All waveforms in FIGS. 17, 18, and 19 are from the reference point of the MBus target interface. Also, the mb_blk_clk signal is the reference clock for all initiator/target pairs shown in the figures, however, it may or may not be the global clock or the clock for any other MBus initiator/target pairs.

FIG. 17 illustrates a multiple burst write sequence on the MBus, according to the protocol of the present invention. FIG. 17 shows a series of two multiple-burst write sequences, in which the communications initiator writes to the target in two groups of data words, the first group consisting of 4 data words and the second group consisting of 2 data words. As described in further detail below, the communications initiator asserts a number of address-related signals and a number of transaction-related signals for each group of data words to be read or written.

First, the communications initiator asserts mb_blk_req to request access to the target over the MBus. Since mb_blk_ardy is high, the target is initialized and enabled and the MBus is ready to respond to the address/command valid strobe mb_blk_astb. Practitioners of the present invention may elect to hold mb_bik_ardy high all the time and allow MBus control to be arbitrated by the initiator and target using the mb_bik_astb and mb_blk_aack signals.

When the initiator is writing data in more than one group of data words, as in this example, the initiator must assert the bus request signal mb_blk_req before the first address/command valid strobe, mb_blk_astb is asserted, and must continue to assert the bus request signal until after the last address/command valid strobe is asserted. Since there are two groups of data words in this sequence, mb_blk_astb is asserted twice, and mb_blk_req stays high until after the second strobe is asserted. Continuing with FIG. 18, the initiator sees mb_bik_ardy high (it is tied high in this example) and can thus assert mb_bik_astb for one clock cycle. When the target sees mb_bik_astb asserted, the target captures the address and transmission-related signals mb_blk_addr, mb_blk_dir, mb_blk_blen, mb bik_brate and mb_bik_astb_tag, which are driven valid by the initiator before the rising edge of the next clock cycle after the address/command valid strobe is asserted. For write commands, mb_blk_dir must be high when mb_blk_astb is asserted; for read commands, mb_blk_dir is low. Because the first transfer is a burst of 4, mb_bik_blen is ‘2’ (as indicated in Table 2 above, the burst length value encodes the number of data words to be transferred in powers of two: a burst length value of 0 indicates a single word of data; a value of 1 indicates 2 words of data, a value of 2 indicates 4 words of data, and so forth, up to a total of 16 words of data.) The mb_blk_astb_tag signal tags transaction requests; it can be a single bit that toggles between 1 and 0 to insure that transactions stay in order. Alternatively, if the SOC will include pipelined, out-of-order, split, or overlapped transactions, more bits may be required to insure that every outstanding transaction has its own unique tag. Next, the target asserts mb_blk_aack for one clock cycle to acknowledge the receipt of the address and indicates that another address cycle may commence, and drives mb_blk_aack_tag valid before the next rising edge of mb_blk_clk. The mb_blk_aack_tag value matches the mb_blk_astb_tag value received from the initiator. Once the initiator receives the mb_blk_aack pulse, it may drive the next mb_blk_addr, mb_blk_dir, mb_blk_blen, mb_blk_brate and mb_blk_astb_tag valid and strobe mb_blk_astb. If mb_bik_req and mb_blk_ardy were continuously asserted, this may occur in the clock cycle immediately after receipt of mb_blk_aack.

When the target is ready to receive the write data, the target asserts mb_bik_wrdy for one clock cycle per data transaction (4 times for the first burst group in this example). Because the initiator asserted a value of ‘0’ for mb_blk_brate in this example, the mb_blk_wrdy strobes may be issued in consecutive clock cycles. Note that mb_blk_wrdy strobes may be initiated before, during or after the clock cycle where mb_blk_aack is asserted. If the optional write ready transaction tag signal mb_blk_wrdy tag is used, the target asserts it during each cycle where mb_blk_wrdy is true; its value must match the value of the corresponding address mb_blk_astb_tag (‘1’ in this example). The initiator sends data on the mb_blk_wdata bus and indicates which bytes of data are valid with mb_blk_bsel. The initiator asserts mb_blk_wstb for one clock cycle per data transaction, updating mb_blk_wdata and mb_blk_bsel with each new mb_blk_wstb. Because mb_blk_wrdy is issued in four consecutive clock cycles, mb_blk_wstb must also be issued in four consecutive cycles. mb_blk_wlstb is asserted concurrent with the final (fourth) mb_blk_stb. If the optional write strobe sequence transaction tag is used, the initiator asserts mb_blk_wstb_tag with each mb_blk_wstb; once again, the value of mb_blk_wstb_tag must match the value of the corresponding address mb_blk_astb_tag. This completes the write sequence for the first group of 4 data words.

Continuing with FIG. 17, in preparation for writing the second burst group, the initiator asserts the second mb_blk_astb and the target asserts mb_blk_aack for one clock cycle in response. When the target is ready to receive data for the second transaction, the target asserts mb_blk_wrdy for one clock cycle per data transaction (2 times in this example). Because the initiator asserted a value of ‘0’ for mb_blk_brate, the mb_blk_wrdy strobes may be issued in consecutive clock cycles. Once again, if the write ready transaction tag is used, the target asserts mb_blk_wrdy_tag (not shown in FIG. 18) during each cycle where mb_blk_wrdy is true; the value of mb_blk_wrdy_tag must match the value of the corresponding address mb_blk_astb tag (‘0’ in this example). The initiator sends data on the mb_blk_wdata bus and indicating which bytes of data are valid with mb_blk_bsel. The initiator asserts mb_blk_wstb for one clock cycle per data transaction, updating mb_blk_wdata and mb_blk_bsel with each new mb_blk_wstb. Because mb_blk_wrdy is issued in two consecutive clock cycles, mb_blk_wstb must also be issued in two consecutive cycles. mb_blk_wlstb is asserted concurrent with the final (second) mb_blk_stb. If the write strobe transaction tag is used, the initiator asserts mb_blk_wstb_tag with each mb_blk_wstb, and, as above, the value of mb_blk_wstb_tag must match the value of the corresponding address mb_blk_astb_tag (‘0’ in this example).

FIG. 18 illustrates a multiple burst read sequence over the MBus. As described above in connection with the multiple burst write sequence, the initiator asserts the bus request signal mb_blk_req before and through the clock cycle that it also asserts the target address strobe mb_blk_astb. In the embodiment shown in FIG. 18, the optional bus grant/address ready signal mb_blk_ardy is tied high, so bus and target resource arbitration is controlled by the interaction of the address strobe and address acknowledge signals. In an alternative embodiment, the bus controller may assert the bus grant/address ready signal mb_blk_ardy in response to the bus request signal to indicate that the bus is ready to respond to an address strobe. In this embodiment, the initiator must see mb_blk_ardy high at least once within the prior 7 clock cycles before asserting mb_blk_astb. Those skilled in the art will recognize that imposing the 7-clock cycle limitation between the mb_blk_ardy assertion and the mb_blk_astb assertion necessarily limits the mb_blk_ardy/mb_blk_astb pipeline depth. Practitioners of the present invention can adjust this limitation as required to accommodate a deeper or shallower pipeline, according to the requirements of the specific design. If truly arbitrary pipelining is needed or desired, mb_blk_ardy must be tied ‘true’, with bus arbitration performed via the mb_blk_astb/mb_blk_aack signal pair as shown in this example.

Returning to FIG. 18, the initiator drives mb_blk_addr, mb_blk_dir, mb_blk_blen, mb_blk_brate and mb_blk_astb_tag valid before the rising edge of mb_blk_clk when it asserts the single-clock cycle address strobe mb_blk_astb. For read commands, mb_bik_dir must be low when mb_blk_astb is asserted. Because the first transfer is a group of 4 words, mb_bik_blen is ‘2’. The target drives mb_blk_aack_tag valid before the rising edge of mb_blk_clk when it asserts mb_blk_aack. It then asserts mb_bik_aack for one clock cycle to acknowledge the receipt of the address and to indicate that another address cycle may commence. As described above in connection with the write sequence, the mb_bik_aack_tag value must match the mb_blk_astb_tag value received from the initiator.

Once the initiator receives the mb_blk_aack pulse, it may drive the next mb_blk_addr, mb_blk_dir, mb_blk_blen, mb_blk_brate and mb_blk_astb_tag valid and assert mb_blk_astb. If mb_blk_req and mb_blk_ardy have been continuously asserted as shown in this example, the initiator can drive these signals valid in the clock cycle immediately after receipt of mb_bik_aack. The mb_blk_astb_tag value for the second strobe (corresponding to the second group of two bursts) must be different (‘0’ in this example) from the preceding tag (‘1’ in this example). The target then asserts mb_blk_aack for one clock cycle in response to the second mb_blk_astb. When read data is available, the target drives mb_blk_rdata valid and asserts mb_blk_rdstb for one clock cycle per data transaction (4 times in this example), updating the read data with each strobe. This may occur before, during or after the clock cycle where mb_blk_aack is asserted. Because the initiator asserted a value of ‘0’ for mb_blk_brate, the mb_blk_rdstb strobes may be issued in consecutive clock cycles. mb_blk_rlstb is asserted concurrent with the last (fourth in this example) mb_blk_rdstb strobe of the burst. If the read strobe transaction tag is used, the target asserts the transaction tag on mb_blk_rdstb_tag (not shown in FIG. 18); this value must match the value of the corresponding address mb_blk_astb_tag (‘1’ in this example). When read data is available for the second transaction, the target drives mb_blk_rdata valid and asserts mb_blk_rdstb for one clock cycle per data transaction (2 times in this example), updating the read data with each strobe. Once again, because the initiator asserted a value of ‘0’ for mb_blk_brate, the mb_blk_rdstb strobes may be issued in consecutive clock cycles. Again, if the read strobe transaction tag is used, the target would assert mb_blk_rdstb_tag with a value that matches the value of the corresponding address mb_blk_astb_tag, which was the second tag having a value of 0 in this example. Finally, mb_blk_rlstb is asserted concurrent with the last (second in this example) mb_blk_rdstb strobe of the burst.

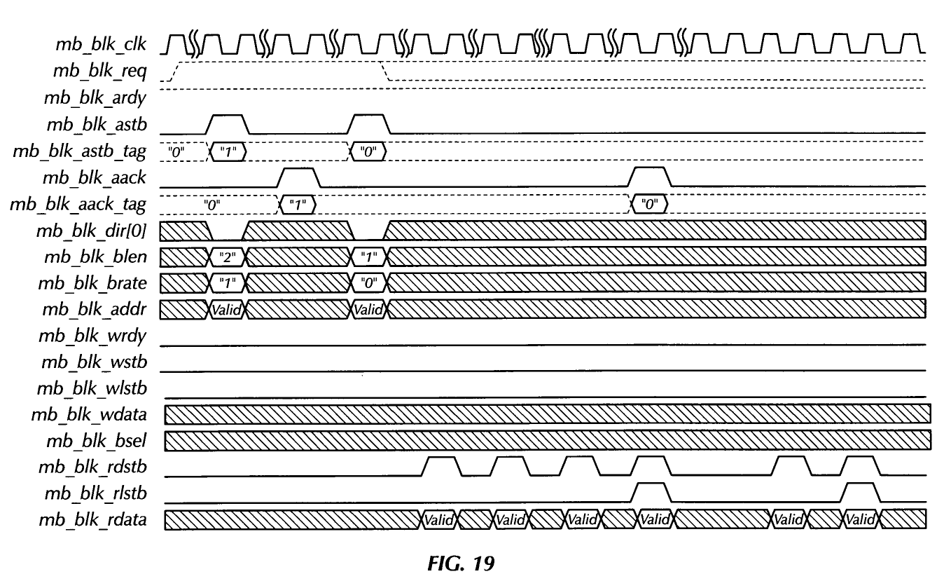

FIG. 19 illustrates a multiple burst read sequence on the MBus, where the burst rate is limited. The bus setup, address strobe and address strobe acknowledgement all occur as described above in connection with FIG. 18. However, in this scenario, the transaction information signal mb_blk_brate corresponding to the first burst group has a value of ‘1’ instead of ‘0’, indicating that the initiator cannot accept mb_blk_rdstb strobes faster than every other clock cycle. FIG. 19 shows that the target responds when read data is available by driving mb_blk_rdata valid and the read strobe mb_blk_rdstb high every other clock cycle, for one clock cycle each per data transaction (4 times in this example), updating the read data with each strobe. As described above, mb_blk_rlstb is asserted concurrent with the last (fourth in this example) mb_blk_rdstb strobe of the burst.

In FIG. 19, as in FIG. 18, the initiator calls for a second burst of data to read by asserting a second address strobe, address strobe tag, and group of transaction information signals. Notice that the initiator indicates that it can receive read data every clock cycle in the second group of two bursts. (mb_blk_brate has a value of ‘0’ for the second transaction.) However, in this example, the target is only able to issue data slower; mb_blk_rdstb strobes are issued every other clock cycle instead of every clock cycle.

To summarize, this present invention is an SOC architecture that provides a clock-latency tolerant synchronous protocol for on-chip bus signals. The SOC includes at least a processor core and one or more peripherals that communicate on a first internal bus that carries signals from signal initiators to signal targets, wherein the signals have a latency tolerant protocol that enables an arbitrary number of pipeline stages between any signal initiator and any signal target. The SOC may also include a shared memory subsystem and DMA-type peripherals that communicate on a second internal bus that carries signals from signal initiators to signal targets, wherein the signals on the second internal bus also have a latency tolerant protocol that enables an arbitrary number of pipeline stages between any signal initiator and any signal target. All signals over both busses are point-to-point and registered and all transactions on both busses are handshaked. An arbitrary number of flip-flops, multiplexing routers, and/or decoding routers may be included between any signal initiator and any signal target on either bus, and may be added at any time during the design and layout of the SOC. The internal busses can have overlapping topologies where each bus can have a matrix fabric (or woven) topology, point-to-point topology, bridged topology, or bussed topology.

Other embodiments of the invention will be apparent to those skilled in the art after considering this specification or practicing the disclosed invention. The specification and examples above are exemplary only, with the true scope of the invention being indicated by the following claims.

We claim the following invention:

1. A System-on-Chip (SOC) apparatus having a latency-tolerant architecture, comprising:
a processor core;
one or more peripherals; and
a first internal bus that couples said processor core to said peripheral(s) and carries signals from signal initiators to signal targets, said first internal bus has a latency tolerant signal protocol that allows an arbitrary number of pipeline stages between any signal initiator and any signal target.

2. The System-on-Chip (SOC) apparatus of claim 1 wherein said one or more peripherals further comprises one or more DMA-type peripherals, and said apparatus further comprises:
a memory subsystem; and
a second internal bus that couples said processor core to said memory subsystem and to said DMA-type peripherals, said second internal bus carries signals from signal initiators to signal targets, said second internal bus has a latency tolerant signal protocol that allows an arbitrary number of pipeline stages between any signal initiator and any signal target.

3. The System-on-Chip (SOC) apparatus of claim 1 or claim 2, wherein said signals are point-to-point and registered signals, and said latency tolerant signal protocol further comprises full handshaking.

4. The System-on-Chip (SOC) apparatus of claim 1 or claim 2, wherein said pipeline stages further comprise one or more of the following: flip-flop, multiplexing router, or decoding router.

5. The System-on-Chip (SOC) apparatus of claim 2, wherein said first internal bus and said second internal bus have overlapping topologies, each topology further comprising one or more of the following topologies: matrix fabric (or woven) topology, point-to-point topology, bridged topology, or bussed topology.

6. A System-on-Chip (SOC) system having a latency-tolerant architecture, comprising:
a processor core;
one or more peripherals; and
a first internal bus that couples said processor core to said peripheral(s) and carries signals from signal initiators to signal targets, said first internal bus has a latency tolerant signal protocol that allows an arbitrary number of pipeline stages between any signal initiator and any signal target.

7. The System-on-Chip (SOC) system of claim 6 wherein said one or more peripherals further comprises one or more DMA-type peripherals, and said system further comprises:
a memory subsystem; and
a second internal bus that couples said processor core to said memory subsystem and to said DMA-type peripherals, said second internal bus carries signals from signal initiators to signal targets, said second internal bus has a latency tolerant signal protocol that allows an arbitrary number of pipeline stages between any signal initiator and any signal target.

8. The System-on-Chip (SOC) system of claim 6 or claim 7, wherein said signals are point-to-point and registered signals, and said latency tolerant signal protocol further comprises full handshaking.

9. The System-on-Chip (SOC) system of claim 6 or claim 7, wherein said pipeline stages further comprise one or more of the following: flip-flop, multiplexing router, or decoding router.

10. The System-on-Chip (SOC) system of claim 7, wherein said first internal bus and said second internal bus have overlapping topologies, each topology further comprising one or more of the following topologies: matrix fabric (or woven) topology, point-to-point topology, bridged topology, or bussed topology.

11. A method to manufacture a System-on-Chip (SOC) apparatus having a latency- tolerant architecture, comprising:
providing a processor core;
providing one or more peripherals; and
coupling a first internal bus to said processor core and to said peripheral(s), said first internal bus carries signals from signal initiators to signal targets, said first internal bus has a latency blerant signal protocol that allows an arbitrary number of pipeline stages between any signal initiator and any signal target.

12. The method of claim 11 wherein said one or more peripherals further comprises one or more DMA-type peripherals, and said method further comprises:
providing a memory subsystem; and
coupling a second internal bus to said processor core, to said memory subsystem, and to said DMA-type peripherals, said second internal bus carries signals from signal initiators to signal targets, said second internal bus has a latency tolerant signal protocol that allows an arbitrary number of pipeline stages between any signal initiator and any signal target.

13. The method of claim 11 or claim 12, wherein said signals are point-to-point and registered signals, and said latency tolerant signal protocol further comprises full handshaking.

14. The method of claim 11 or claim 12, wherein said pipeline stages further comprise one or more of the following: flip-flop, multiplexing router, or decoding router.

15. The method of claim 12, wherein said first internal bus and said second internal bus have overlapping topologies, each topology further comprising one or more of the following topologies: matrix fabric (or woven) topology, point-to-point topology, bridged topology, or bussed topology.

16. A method of using a System-on-Chip (SOC) apparatus having a latency-tolerant architecture, comprising:
providing a processor core;
providing one or more peripherals; and
carrying signals from signal initiators to signal targets over a first internal bus that couples said processor core to said peripheral(s), said first internal bus has a latency tolerant signal protocol that allows an arbitrary number of pipeline stages between any signal initiator and any signal target.

17. The method of claim 16 wherein said one or more peripherals further comprises one or more DMA-type peripherals, and said method further comprises:
providing a memory subsystem; and
carrying signals from signal initiators to signal targets over a second internal bus that couples said processor core to said memory subsystem and to said DMA-type peripherals, said second internal bus has a latency tolerant signal protocol that allows an arbitrary number of pipeline stages between any signal initiator and any signal target.

18. The method of claim 16 or claim 17, wherein said signals are point-to-point and registered signals, and said latency tolerant signal protocol further comprises full handshaking.

19. The method of claim 16 or claim 17, wherein said pipeline stages further comprise one or more of the following: flip-flop, multiplexing router, or decoding router.

20. The method of claim 17, wherein said first internal bus and said second internal bus have overlapping topologies, each topology further comprising one or more of the following topologies: matrix fabric (or woven) topology, point-to-point topology, bridged topology, or bussed topology.
